(19) United States
(12) Patent Application Publication
(10) Pub. No.: US 2017/0238067 A1
(43) Pub. Date: Aug. 17, 2017

(54) SYSTEMS AND METHODS FOR DYNAMIC CREATIVE OPTIMIZATION FOR VIDEO ADVERTISEMENTS

(71) Applicant: Adobe Systems Incorporated, San Jose, CA (US)

(72) Inventors: Saurabh Sharma, Noida (IN); Ishan Aggarwal, Delhi (IN); Ashish Duggal, Delhi (IN); Niraj Gupta, Haryana (IN); Jens M. Loeffler, Cranford, NJ (US); Atul Kumar Shrivastava, Noida (IN); Jonathan Tabak, Los Angeles, CA (US); Morgan Gurfinkel, New York, NY (US)

(21) Appl. No.: 15/045,878

(22) Filed: Feb. 17, 2016

(51) Int. Cl. H04N 21/81; H04N 21/25; H04N 21/466; H04N 21/45; H04N 21/258

(52) U.S. Cl. CPC H04N 21/812; H04N 21/4532; H04N 21/25891; H04N 21/4667; H04N 21/251

(57) ABSTRACT

Embodiments are disclosed that provide dynamic creative optimization for video advertisements. In certain embodiments, a content creation system receives a request for a video advertisement from a remote computing system. The request represents attributes of a specific recipient. To generate the video advertisement, the content creation system accesses a collection of assets, such as templates and video elements, from which video content can be generated. The content creation system selects a subset of assets from the collection and combines some or all of the selected subset of assets into a composite content file. The content creation system generates (or causes another system to generate) the requested electronic video advertisement or other video content from the composite content file. The content creation system provides the generated video advertisement or other video content in response to the request that was received from the remote computing system.

### TECHNICAL FIELD

This disclosure relates generally to computer-implemented video content creation and more particularly relates to systems and methods for dynamically performing creative optimization of electronic video advertisements.

### BACKGROUND

Digital marketers and other providers of online services provide content that customized to certain users, households, or other logical entities. For example, it may be desirable for an online advertisement provider to tailor an advertisement to a given user's recent browsing history, location, demographic information, or some other attribute of the user's consumer profile. To address this need, a digital marketer may use a content creation system to customize advertisements to specific users (e.g., individuals or households) according to particular attributes of those users, rather than simply providing advertisements based on generalized demographic conclusions. For instance, as a user navigates various online websites, they may view numerous advertisements provided by various digital marketers. A digital marketer may wish to customize the content of its provided advertisements to better capture the user's attention. The digital marketer may also prefer to provide advertisements related to a user's recent browsing history, to improve user engagement, rates of customer conversion, or other metrics relating to advertising campaigns.

Digital marketers and other online content providers may therefore tailor advertising content to a given user. Certain data management systems are used to identify market segments (e.g., male homeowners, aged 62-67, having an income between $50,000-$55,000) and their associated users by using data collected from multiple users' online interactions. In a simplified example, a data management system with access to large amounts of data from multiple online interactions will identify user attributes indicating successful (or unsuccessful) conversions resulting from interactions with electronic advertisements. The data management system provides these identified attributes to a content creation system, which uses the identified attributes to provide dynamically created advertisements (or other content) suitable to a given user's particular attributes.

A prior solution for providing such personalized advertisements involves providing customized image-based advertisements, such as advertisements using a JPEG format or a GIF format. In this solution, a user's particular attributes are correlated with identified audience attributes, and based on the correlation, still images appropriate to the user attributes may be assembled into an image-based advertisement. For instance, a user with attributes indicating an interest in car customization, a location in a certain city, and probable income of a certain bracket may receive an advertisement that includes images of a high-end car product, and an address and map of the nearest auto parts supplier carrying the product. The still images may be selected, assembled into an advertisement, and the advertisement delivered to the user's browser (or other application) with little or no delay noticeable to the user.

This solution presents certain disadvantages. For example, users may be accustomed to disregarding image-based advertisements in their browsers. Therefore, customized image-based advertisements offer an insufficient improvement in customer conversion or other metrics.

Another prior solution involves joining video clips together in succession, also known as video “stitching.” Stitching may allow a digital marketer to provide a partially customized video advertisement, such as by joining a brief video clip of a map and address to the end of a generalized advertisement for a retail store. A video advertisement may also be stitched to the front of a content video, which encourages a user to watch the advertisement in order to view the desired content video. However, this solution is limited to joining completed video clips in an end-to-end manner, which prevents extensive customization of the advertisement content.

In addition, the video clips that are available to be stitched must be filmed and converted to a suitable format, such as MP4, before the stitching occurs. This conversion involves a large amount of time and effort that must be invested before the video clips are available for stitching, and limits the number of user attributes to which the video advertisement may be correlated. For example, although a user's browsing history may indicate a recent interest in baby clothes, antacids, and printer ink, it is unlikely that the available video clips will include this precise combination of items. Therefore, stitching cannot be used to generate a video advertisement having a sufficient correlation to the attributes of a particular user, which reduces the user's receptiveness to the advertisement.

Therefore, it is desirable to provide methods and systems to increase the customization of electronic video advertisements based on a given user's attributes.

### SUMMARY

According to certain embodiments, systems and methods are provided for display of dynamic creative optimization for video advertisements. In one example, a content creation system receives a request for a video advertisement from a remote computing system. The request represents attributes of a specific recipient. To generate the video advertisement, the content creation system accesses a collection of assets, such as templates and video elements, from which video content can be generated. The content creation system selects a subset of assets from the collection and combines some or all of the selected subset of assets into a composite content file. The content creation system generates (or causes another system to generate) the requested electronic video advertisement or other video content from the composite content file. The content creation system provides the generated video advertisement or other video content in response to the request that was received from the remote computing system.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

Features, embodiments, and advantages of the present disclosure are better understood when the following Detailed Description is read with reference to the accompanying drawings, where:

FIG. 1 is a block diagram depicting a computing environment in which a content creation system provides customized electronic video content that is generated from selected assets according to certain embodiments;

FIG. 2 is a diagram depicting an example of a template having multiple layers that are associated with a selected subset of assets used by the content creation system of FIG. 1 to provide customized electronic video content according to certain embodiments;

FIG. 3 is a diagram depicting an example of a composite content file including a combination of assets used by the content creation system of FIG. 1 to provide customized electronic video content according to certain embodiments;

FIG. 4 is a diagram depicting another example of a composite content file including another combination of assets used by the content creation system of FIG. 1 to provide customized electronic video content according to certain embodiments;

FIG. 5 is a flow chart depicting an example of a process for providing a customized electronic video content item according to certain embodiments;

FIG. 6 is a flow chart depicting an example of a process for selecting a subset of assets used in the process of FIG. 5 for providing the customized electronic video content item according to certain embodiments;

FIG. 7 is a flow chart depicting an example of a process for generating the customized electronic video content item provided by the process of FIG. 5 according to certain embodiments; and

FIG. 8 is a block diagram depicting an example of an implementation of a content creation system according to certain embodiments.

### DETAILED DESCRIPTION

As discussed above, prior techniques for generating electronic video advertisements may be limited in the amount of available customization due to limitations on the elements that may be used to generate video content items. Embodiments are disclosed that provide customized electronic video advertisements in real-time or nearly real-time, by associating multiple video elements to layers within a template. The template and video elements used to provide customized electronic video advertisements are selected according to personal attributes specific to an intended recipient of the electronic video advertisement (e.g., demographic or behavioral attributes of a user who will receive the electronic video advertisement). These embodiments allow increased customization of generated video content items with respect to targeted users or groups.

The following example is provided to introduce certain embodiments of the present disclosure. In some embodiments, a content creation system receives a request for a video advertisement from a remote computing system, such as an ad call received from an application running on a personal computing device of a user. The request represents attributes of a specific recipient, such as (but not limited to) a particular user to whom the video advertisement will be targeted. To generate the video advertisement, the content creation system accesses a collection of assets from which video content can be generated. For example, the collection of assets may include video elements for an advertising campaign. Such video elements could include (without limitation) visual elements (e.g., video clips), audio elements (e.g., soundtracks, dialogue, etc.), formatting elements, and text elements. The collection of assets may also include templates representing particular video advertisement formats and having layers that may be associated with other video elements. The collection of assets may also include additional information, such as a list of current promotional offers, that could be used to generate video advertisements. In some embodiments, the collection is provided and maintained by a third party, such as (but not limited to) a retailer running an online marketing campaign, with which the content creation system can communicate via a network.

In this example, the content creation system selects a subset of assets from the collection to generate the requested video advertisement. In certain embodiments, the content creation system combines some or all of the selected subset of assets into a composite content file. The composite content file includes a template with layers, where a particular layer is associated with a particular video element from the subset of assets. The composite content file may or may not be viewable in a human-readable format. The content creation system generates (or causes another system to generate) the requested electronic video advertisement or other video content from the composite content file such that the combination of assets included in the composite content file can be viewed, heard, or both in the generated video advertisement. The content creation system provides the generated video advertisement or other video content in response to the request that was received from the remote computing system. In some embodiments, the content creation system provides the generated video advertisement or other video content to the remote computing system from which the request was received. In other embodiments, the content creation system provides the generated video advertisement or other video content to a remote computing system different from the computing system from which the request was received.

As used herein, the term “electronic video advertisement” is used to refer to an advertisement with video elements, audio elements, or both that is generated and presented in an electronic computing environment. In some embodiments, the electronic video advertisement includes a combination of video content items.

As used herein, the term “video content item” is used to refer to any media asset (e.g., video content, audio content, etc.) that can be included in electronic video advertisement and that can be seen or heard when the electronic video advertisement.

Although the disclosed embodiments are generally described for video advertisements, the disclosed embodiments may be extended to non-advertising electronic video content items. For example, in some embodiments, the content creation system receives, from a remote computing system, a request for a video content item that is not an advertisement. The requested video content item may be a series of headlines in a video news program. The content creation system generates or otherwise provides the customized video news program in a manner similar that described for electronic video advertisements.

As used herein, the term “real-time” refers to a period of time that is short enough to avoid noticeable delay, unless otherwise noted. In one example, providing a video content item to a recipient in real-time indicates that the video content item is provided to the recipient in a period of time such that the recipient does not notice a delay. In various embodiments, “real-time” operations involve different periods of time for different operations involved in generating customized electronic video advertisements, or for different requests received by different applications on different remote computing systems. For example, a video-viewing application running on a mobile device may require a video advertisement in a relatively shorter period of time to prevent loss of interest by a recipient who is watching a video in the viewing application. By comparison, a browser application running on a desktop computer may require a video advertisement in a relatively longer period of time to attract the attention of a recipient who is concentrating on other content displayed in the browser application.

As used herein, the term “collection of assets” refers to a group of electronic information items used for personalized video content of a certain type. The term “asset” refers to a member item of such a collection, unless otherwise noted. Any suitable type of video content can be generated from an appropriate collection of assets. In some embodiments, an asset includes templates representing particular video content formats and having layers that may be associated with other assets, such as video elements. In one example, a collection of assets includes video elements and promotional information used for personalized video advertisements for an advertising campaign. In another example, a collection of assets includes video elements and sports outcome information used for personalized sports video content. It is envisioned that certain assets may be previously provided by a user, to be included in personalized video content generated for the user or other recipients associated with the user.

As used herein, the term “video element” refers to one or more image assets or graphical assets suitable for generating a video content item. In some embodiments, a video element includes moving visual elements, such as video clips or other collections of sequential image assets. In additional or alternative embodiments, a video element includes still images, product logos, or backgrounds. In additional or alternative embodiments, a video element includes effect elements, such as fade-in or fade-out effects, colorizing effects (sepia, black-and-white, etc.), and other effects for modifying the appearance of video content.

As used herein, the term “audio element” refers to one or more audio assets suitable for generating a video content item. Examples of audio elements include dialogue, voice-overs, advertising “jingles,” or background music.

As used herein, the term “text element” refers to one or more textual assets suitable for generating a video content item. Examples of text elements include product titles, promotional text (discounts, percentages, etc.), contact information.

Additional elements are also envisioned, such as blinking elements for a light-emitting diode, or haptic elements for mobile devices or low-vision computing devices.

As used herein, the term “composite content file” refers to a combination of electronic information items that may be used in the generation of a video content item. In some embodiments, a composite content file includes a template with layers, where a particular layer is associated with a particular video element. In various embodiments, the composite content file includes the video elements associated with certain template layers, includes references addresses that are directed to the video elements associated with certain template layers, or includes both video elements themselves and references to video elements. A composite content file may or may not be viewable in a human-suitable format.

In some embodiments, the content creation system uses a composite content file to render or otherwise generate a video content item, such that the video elements associated with the template layers can be viewed, heard, or both in the generated video. In additional or alternative embodiments, a composite content file includes or is associated with additional instructions (e.g., “scripting” instructions), such as instructions indicating an expiry time for a request, a screen resolution at which the video content item should be generated, etc.

As used herein, the term “rendering” refers to the process of converting assembled elements of video content items into a resulting video file, unless otherwise noted. In one example, rendering a composite content file includes converting the elements represented by the composite content file into a finalized video file of a suitable viewing format, such as (but not limited to) an .MP4 file format. The phrases “rendering a composite file,” “rendering a video,” and “rendering a file,” may be understood to equally describe the process of converting a combination of video elements into a video file suitable for viewing, hearing, or distribution. In some embodiments, rendering a file includes converting audio elements or effect elements (e.g., fade in, fade out, etc.) to be included in the resulting video file. The phrase “rendered video file” may be understood to be a video file that results from rendering, as described above.

As used herein, the term “recipient” is used to refer to an entity, such as a user, for which a video content item has been requested, unless otherwise noted. A recipient may be an individual, organization, or other logical identity. A recipient may be uniquely identified by a content creation system, a data management system, or other application. In various embodiments, recipients are identified by reference to one or more identification phrases. In various embodiments, recipients may be associated with one or more attributes.

As used herein, the term “attribute” is used to refer to a trait of a recipient that is used by a content creation system to generate or otherwise provide customized video content. Types of attributes include (but are not limited to) personal characteristics of the recipient, device characteristics of the recipient's computing device, patterns of computer usage, or preferences described by a personal profile. In some embodiments, attributes are received by the content creation system, such as a device ID or an IP address received with a request for an electronic video advertisement. In additional or alternative embodiments, the content creation system communicates with a data management system that identifies additional attributes, such as a probable age range or probable interests for a recipient. An electronic designation that uniquely identifies a recipient, such as identification phrase, may be used to identify attributes. A particular attribute may have more than one of the example traits disclosed here, or may have additional traits not disclosed. Attributes may be a single value (such as an IP address), a range of values (such as an income range), or a set of data (such as a browsing history). Attributes may be derived from behaviors of a larger user population. Attributes may have an associated probability; for example, a gender attribute for a particular recipient may have a 73% probability of being male. Examples of attributes based on personal characteristics include (but are not limited to) a recipient's age, gender, geographical location, income, group affiliation (e.g., political, social, or professional organizations, etc.), education level, languages spoken, demographic characteristics, business title from a business website, etc. Examples of attributes based on device characteristics include (but are not limited to) a device identification, device serial number, IP address, operating system, preferred device language, etc. Examples of attributes based on patterns of computer usage include (but are not limited to) a browsing history, an online purchase or transaction history, a history of content viewed, a pattern of computer access at certain times of day, a pattern of computer access at certain geographical or network locations, etc. Examples of attributes based on preferences described by a personal profile include (but are not limited to) an indicated interest in selected hobbies, an indicated interest in selected communications (e.g., receiving text messages, “sharing” messages with associated users, etc.), membership in one or more incentive or loyalty programs (e.g., coupons, point rewards, etc.), membership in one or more social media services, etc.

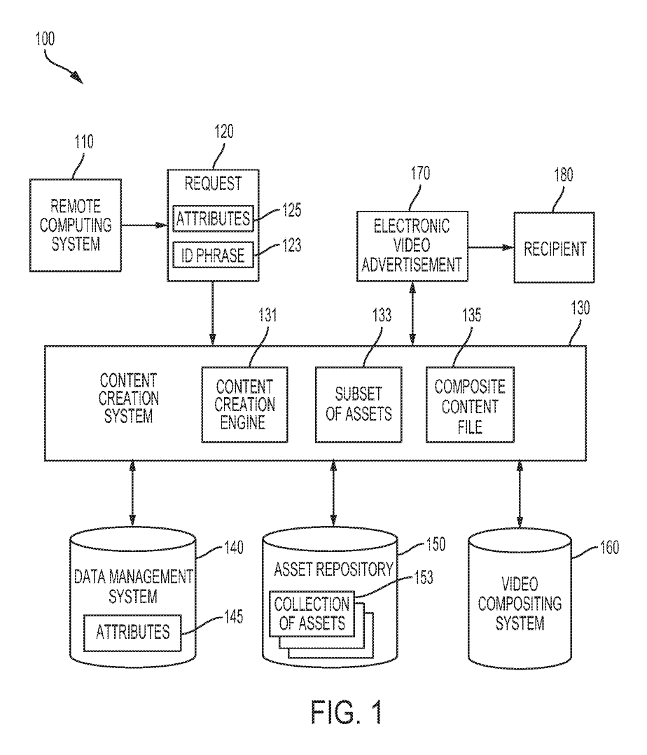

Referring now to the drawings, FIG. 1 is a block diagram depicting an example of a computing environment 100 in which a content creation system 130 provides a customized electronic video content item (e.g., a personalized electronic video advertisement 170) that is generated from certain selected assets. The depicted computing environment 100 includes the content creation system 130 as well as one or more other computing systems in communication with the content creation system 130, such as a remote computing system 110, a data management system 140, and a video compositing system 160.

The content creation system 130 is used to generate customized video content. The content creation system contains a content creation engine 131 including computer code suitable to perform the operation described herein. In some embodiments, the content creation system 130 receives a request 120 to provide an electronic video advertisement. The request 120 is received from the remote computing system 110 via a data network or other suitable communication channel. The request 120 includes or otherwise indicates one or more attributes that are specific to a recipient 180 of the requested video advertisement. In some embodiments, these attributes are included with the request 120, as depicted by the received attributes 125 in FIG. 1. In additional or alternative embodiments, the attributes are obtained by the content creation system 130 from a data management system 140 using information from the request 120. For example, the content creation system 130 may obtain additional attributes 145 from the data management system 140, as described below. In some embodiments, the request 120 additionally or alternatively includes an identification phrase 123 associated with the recipient 180 of the requested video advertisement. In some embodiments, the identification phrase 123 is provided to the data management system 140 as described below.

In some embodiments, the content creation system 130 communicates with or otherwise accesses an asset repository 150 via a network. In response to receiving the request 120, the content creation system 130 accesses, via the network, one or more collections of assets 153 stored in the asset repository 150. Based on the attributes represented by the request 120, the content creation system 130 selects a subset of assets 133 from the accessed collection of assets 153.

The subset of assets 133 includes, for example, one or more templates and one or more video elements. In certain embodiments, the subset of assets 133 also includes information relevant to generating a personalized electronic video advertisement. In some embodiments, a copy of the selected subset of assets (or one or more particular assets of the subset) is transmitted via the network and stored locally with the content creation system 130. In additional or alternative embodiments (not shown), the selected subset of assets remains with the asset repository 150, and the content creation system 130 accesses the subset via the network.

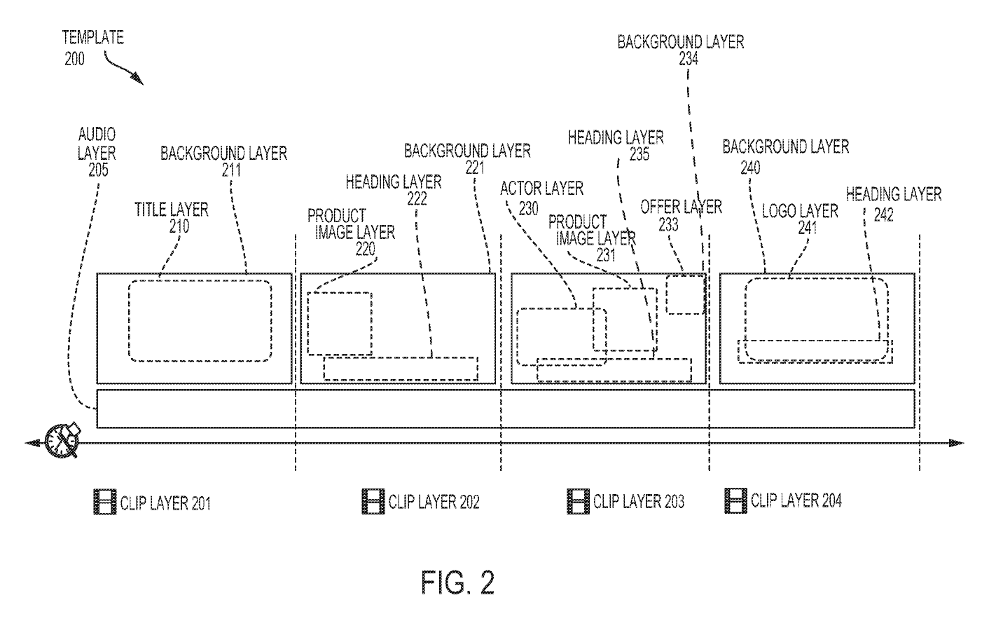

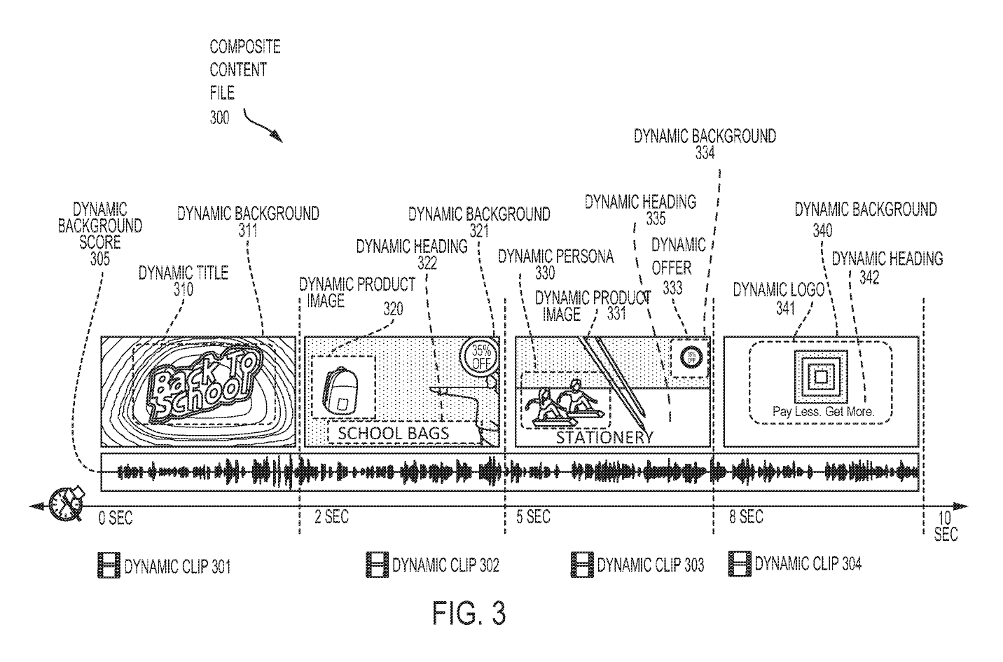

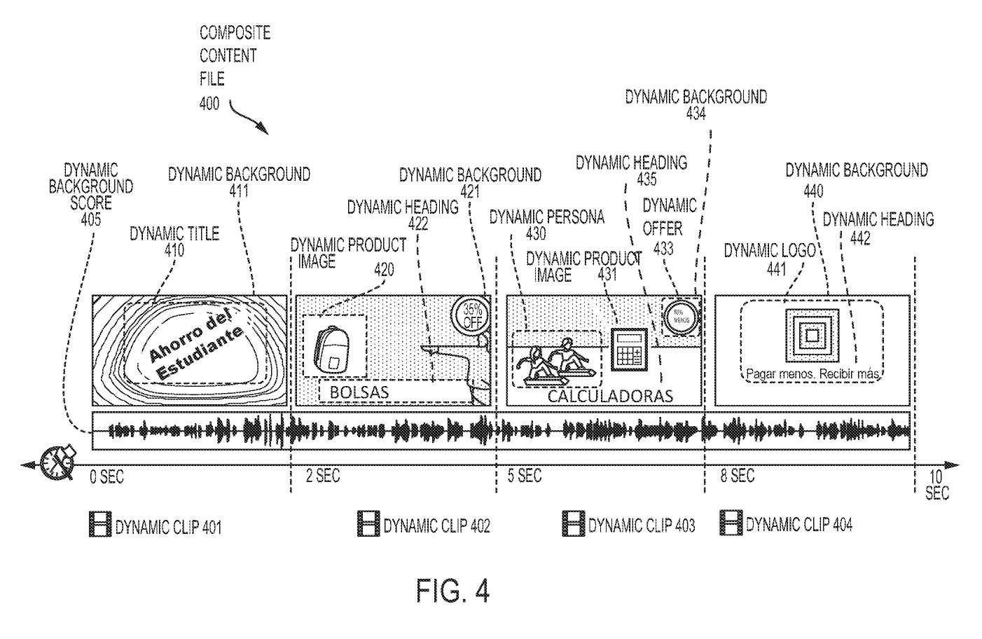

In the example depicted in FIG. 1, the content creation system 130 creates, from the selected subset of assets 133, a composite content file 135 that includes a combination of assets from the selected subset. The combination of assets used in creating the composite content file 135 may represent some or all of the selected subset. The created composite content file 135 includes a template with layers, as described in detail with respect to FIG. 2. A particular layer is associated with a particular video element from the subset of assets 133, as described in detail with respect to FIGS. 3 and 4. In some embodiments, the created composite content file 135 includes the particular video elements associated with particular template layers. In additional or alternative embodiments, the composite content file 135 includes reference addresses that are directed to the particular video elements associated with particular template layers.

The content creation system 130 generates (or causes one or more other systems to generate) the electronic video advertisement 170 based on the created composite content file 135. The combination of assets used in creating the composite content file 135 is visible, audible, or otherwise perceptible in the generated electronic video advertisement 170. In certain embodiments, the content creation system 130 generates the electronic video advertisement 170. In additional or alternative embodiments, the content creation system 130 instructs a video compositing system 160 to generate the electronic video advertisement 170, as described below in regards to video compositing system 160.

The content creation system 130 provides the generated electronic video advertisement 170 in response to the request 120 received from the remote computing system 110. The generated electronic video advertisement 170 is provided for the recipient 180 associated with the attributes represented by the received request 120, or with the identification phrase 123, or with both. In some embodiments, the content creation system 130 provides the generated video advertisement 170 to the remote computing system 110 from which the request 120 was received. In other embodiments, the content creation system 130 provides the generated video advertisement 170 to a remote computing system different from the computing system from which the request 120 was received. In some embodiments, the content creation system 130 implements a “failsafe” logic in which the content creation system 130 provides a generalized electronic video advertisement in response to the request 120 in the event that a personalized video cannot be generated.

Any suitable attributes can be included in or otherwise indicated by the request 120. For example, attributes 125 received with a request 120 may include (without limitation) technical information regarding the remote computing system, such as an IP address, a device identification, a device type (e.g., mobile device, laptop, etc.), an application type (e.g., a browser, video playback application, etc.), a screen resolution, etc. Attributes 125 received with a request 120 may additionally or alternatively include (without limitation) information regarding the recipient 180, such as a user identification or preferences from a user profile stored on the remote computing system 110.

In additional or alternative embodiments, an electronic designation that uniquely identifies the recipient 180, such as an identification phrase 123, is received with a request 120. In some embodiments, the content creation system 130 extracts the identification phrase 123, one or more attributes 125 received with the request, or both from the request 120. In some embodiments, the content creation system 130 selects a subset of assets 133 from the collection of assets 153 based on one or more extracted attributes, the identification phrase 123, or both.

In some embodiments, the content creation system 130 provides the identification phrase 123, the extracted attributes, or both to a data management system 140. The data management system 140 determines one or more additional attributes 145 based on the identification phrase 123, the extracted attributes, or both. The additional attributes 145 may include (without limitation) a browser history associated with the identification phrase 123, a set of user preferences from a profile associated with the identification phrase 123, a demographic profile associated with the extracted attributes, etc. The content creation system 130 receives one or more additional attributes 145 from the data management system 140 via a data network. The content creation system 130 selects a subset of assets 133 from collection of assets 153 based on one or more additional attributes 145, or the extracted attributes, or based on both.

As described above, an electronic video advertisement 170 is generated based on the created composite content file 135, such that the combination of assets used in creating the composite content file 135 is visible, audible, or otherwise perceptible in the generated electronic video advertisement 170. In some embodiments, the content creation system 130 generates the electronic video advertisement 170 based on the composite content file 135.

In additional or alternative embodiments, the content creation system 130 provides the created composite content file 135 to a video compositing system 160. The content creation system 130 instructs the video compositing system 160 to generate the electronic video advertisement 170 based on the composite content file 135. In some embodiments, the video compositing system 160 is a distributed computing system that includes multiple nodes. The generation of a file may be performed on the multiple nodes in parallel. In some embodiments, the video compositing system 160, responsive to receiving a particular composite content file 135 containing reference addresses directed to the associated video elements, accesses the asset repository 150 for the associated video elements via a data network.

In additional or alternative embodiments, the content creation system 130 provides additional instructions (not shown) to the video compositing system 160. These additional instructions describe one or more details regarding generation of the electronic video advertisement 170. For example, the additional instructions may include “scripted” commands or simplified instructions, which may describe (without limitation) details such as a screen resolution, a video file format, a delivery application (e.g., browser, video viewing application, etc.). The video compositing system 160 generates the electronic video advertisement 170 based on the provided composite content file 135 and additional instructions provided by the content creation system 130. In some embodiments, the generated electronic video advertisement 170 includes a video file that is rendered using the composite content file 135. The content creation system 130 receives the generated electronic video advertisement 170 from the video compositing system 160 via a data network.

In some embodiments, a template is included in the subset of assets 133. For example, FIG. 2 is a diagram depicting an example of a template 200 having multiple layers that are associated with a selected subset of assets 133 used by the content creation system 130 to provide customized electronic video content. It is to be noted that all described layers, element types, and associations are provided for illustrative purposes only.

The template 200 includes multiple layers. The layers can be associated with one or more elements of different types from the subset of assets 133. For instance, a particular type of element may be associated with more than one particular layer. Although the template 200 is described as having layers associated with particular types of elements or other assets, such described associations are provided for illustrative purposes only.

In some embodiments, each layer is additionally associated with one or more parameters, such as a parameter describing what type of element the layer is capable of being associated with, a parameter describing if the layer must be associated with an element or may be left unassociated, etc. Although the template 200 is illustrated visually in FIG. 2, it is to be understood that a template with layers may or may not be implemented in a format suitable for human viewing.

In this example, the template 200 includes video clip layers 201, 202, 203, and 204, and further includes an audio layer 205. In some embodiments, the video clip layers 201, 202, 203, and 204 are associated with respective video clip elements. In alternative or additional embodiments, the clip layers 201-204 may be associated with parameters describing video qualities (e.g., video fade-in/out effects, time limitation on particular video clips, etc.). The audio layer 205 is associated with one or more audio elements, such as a background music element, dialogue elements, parameters describing audio qualities (e.g., audio fade-in or fade-out effects, volume, etc.), etc.

In this example, the template 200 further includes background layers 211, 221, 234, and 240. The background layers 211, 221, 234, and 240 are associated with background elements, such as images, video clips, or computer-generated elements (e.g., color effects, etc.).

The template 200 depicted in FIG. 2 also includes a title layer 210, a logo layer 241, and heading layers 222, 235, and 242. Each of these layers may be associated with a text element, an image element, or both. The template 200 further includes product image layers 220 and 231, each of which may be associated with an image element or a video clip element. The template 200 further includes an actor layer 230, which may be associated with an image element or a video clip element depicting one or more actors for a generated video content item.

The template 200 further includes an offer layer 233, which may be associated with a text element or an image element. In additional or alternative embodiments, the offer layer 233 may be associated with a computer-generated element that is based on other assets from the selected subset of assets 133. For example, the offer layer 233 may be associated with a particular text element that is selected based on a list of current promotional offers.

In some embodiments, as described above, the content creation system 130 selects a subset of assets 133 from a collection of assets 153. One or more video elements and additional information indicating current promotional offers may be included in the selected subset of assets 133. In some embodiments, the content creation system 130 creates a composite content file 135 including a combination of assets from the selected subset 133.

In some embodiments, the content creation system 130 includes, based on attributes represented by a first request, video elements and additional information indicating current promotional offers may be included in a first selected subset of assets. Additionally, based on attributes represented by a second request, video elements and additional information indicating current promotional offers may be included in a second selected subset of assets. A template 200 having multiple layers, as described above in relation to FIG. 2, is additionally included in the first and second subsets of assets.

FIG. 3 is a diagram depicting an example of a composite content file 300 including a combination of assets used by the content creation system 130 to provide customized electronic video content. The content creation system 130 creates a first composite content file 300 from a first subset of assets that are obtained in response to a first request. The first composite content file 300 includes a first combination of assets.

To create the first composite content file 300, the content creation system 130 associates a dynamic clip 301, dynamic clip 302, dynamic clip 303, and dynamic clip 304 with respective video clip layers 201, 202, 203, and 204. The content creation system 130 associates the dynamic background score 305 with audio layer 205. The content creation system 130 further associates dynamic backgrounds 311, 321, 334, and 340 with respective background layers 211, 221, 234, and 240. The content creation system 130 further associates dynamic title 310 with title layer 210, dynamic logo 341 with logo layer 241, and dynamic headings 322, 335, and 342 with respective heading layers 222, 235, and 242. The content creation system 130 further associates dynamic product image 320 and dynamic product image 331 with respective product image layers 220 and 231. The content creation system 130 further associates dynamic persona 330 with actor layer 230. The content creation system 130 further associates dynamic offer 333 with offer layer 233. In some embodiments, the dynamic offer 333 is generated by the content creation system 130 from a first combination of assets in the first subset, such as by combining text with information from a list of current promotions.

FIG. 4 is a diagram depicting another example of a composite content file including a different combination of assets used by the content creation system 130 to provide customized electronic video content. The content creation system 130 creates a second composite content file 400 from a second subset of assets obtained in response to receiving a second request. The second composite content file 400 includes a second combination of assets.

To create the second composite content file 400, the content creation system 130 associates a dynamic clip 401, dynamic clip 402, dynamic clip 403, and dynamic clip 404 with respective video clip layers 201, 202, 203, and 204. The content creation system 130 associates a dynamic background score 405 with the audio layer 205. The content creation system 130 further associates dynamic backgrounds 411, 421, 434, and 440 with respective background layers 211, 221, 234, and 240. The content creation system 130 further associates dynamic title 410 with title layer 210, dynamic logo 441 with logo layer 241, and dynamic headings 422, 435, and 442 with respective heading layers 222, 235, and 242. The content creation system 130 further associates dynamic product image 420 and dynamic product image 431 with respective product image layers 220 and 231. The content creation system 130 further associates dynamic persona 430 with actor layer 230. The content creation system 130 further associates dynamic offer 433 with offer layer 233. In some embodiments, the dynamic offer 433 is generated by the content creation system 130 from a second combination of assets in the second subset, such as by combining text with information from a list of current promotions.

Although the composite content files 300 and 400 are illustrated visually in FIGS. 3 and 4, it is to be understood that a composite content file may or may not be implemented in a format suitable for human viewing.

A first electronic video advertisement is generated from the first composite content file 300, and provided in response to the first request and for a first recipient. The first combination of assets, as generally described by FIG. 3, is perceptible in the first electronic video advertisement. A second electronic video advertisement is generated from the second composite content file 400, and provided in response to the second request and for a second recipient. The second combination of assets, as generally described by FIG. 4, is perceptible in the second electronic video advertisement.

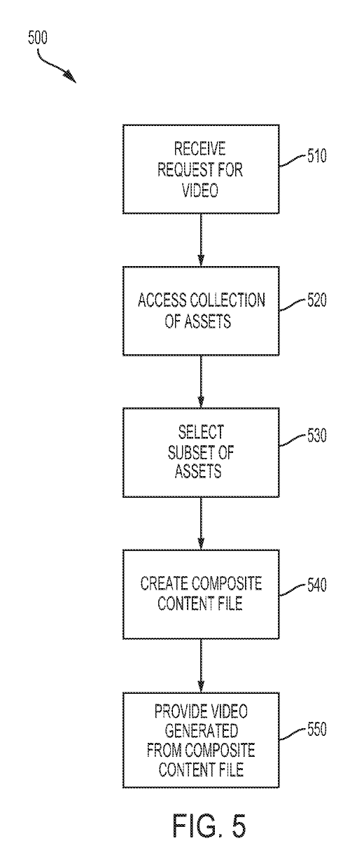

FIG. 5 is a flow chart depicting an example of a process 500 for creating a composite content file based on a received request for an electronic video content item, and providing an electronic video content item generated from the composite content file. In some embodiments, a content creation system 130 implements operations depicted in FIG. 5 by executing suitable program code. For illustrative purposes, the process 500 is described with reference to the examples depicted in FIGS. 1-4. Other implementations, however, are possible.

At block 510, the process 500 involves receiving a request for an electronic video content item, such as an electronic video advertisement. The received request represents attributes specific to a recipient. In some embodiments, the request represents an identification phrase associated with the recipient. For example, a content creation system 130 receives a request 120 to provide an electronic video advertisement to a recipient 180. In some embodiments, the content creation system 130 extracts, from the request 120, an identification phrase 123 that identifies the recipient 180, and one or more attributes 125 received with the request 120, such as the IP address of the remote computing system 110. In additional or alternative embodiments, the content creation system 130 provides the identification phrase 123 to a data management system 140, and the represented attributes are received from the data management system 140, such as additional attributes 145.

At block 520, the process 500 involves accessing a collection of assets. In some embodiments, a collection of assets 153 is stored in an asset repository 150 and is retrieved by the content creation system 130 via a data network. Examples of assets included in the collection of assets 153 include video elements, templates, and information relevant to generating an electronic video content item.

At block 530, the process 500 involves selecting a subset of assets from the accessed collection of assets. The subset of assets is selected based on the attributes represented by the received request. The selected subset of assets contains one or more video elements and one or more templates. In some embodiments, the selected subset of assets contains additional information relevant to generating an electronic video content item. For example, the content creation system 130 selects a subset of the assets 133 from the accessed collection(s) 153, based on the attributes extracted from the request or the additional attributes 145 received from the data management system 140, or both. In this example, the selected subset of assets 133 includes one or more templates, one or more video elements, and additional information indicating current promotional offers.

At block 540, the process 500 involves creating a composite content file that includes a combination of assets from the selected subset of assets. The created composite content file includes a template, and particular layers of the template are associated with respective video elements. For example, the content creation system 130 creates a composite content file 135 including a template; a background element associated with a template layer capable of being associated with background elements; a video clip element associated with a template layer capable of being associated with video clip elements; an audio element associated with a template layer capable of being associated with audio elements; and additional elements associated with additional layers, where a respective additional element is associated with a respective additional layer that is capable of being associated with elements of the respective type.

In some embodiments, the created composite content file 135 includes the particular video elements associated with respective template layers. In additional or alternative embodiments, the composite content file includes addresses that reference locations of the particular video elements associated with particular template layers. In some embodiments, the particular video element associated with a particular layer is contained in the selected subset of assets 133. In additional or alternative embodiments, the particular video element associated with a particular layer is generated, such as by content creation system 130, based on one or more of the selected subset of assets 133.

At block 550, the process 500 involves providing an electronic video content item that is generated from the composite content file. The generated electronic video content item is provided in response to the received request. In some embodiments, a content creation system 130 generates the electronic video content item, such as an electronic video advertisement 170. In additional or alternative embodiments, the content creation system 130 instructs a video compositing system 160 to generate the electronic video content item. In some embodiments, the generated electronic video content item is provided to a remote computing system 110 from which the request was received. In additional or alternative embodiments, the generated electronic video content item is provided to a remote recipient 180 that is different from the computing system 110 from which the request was received.

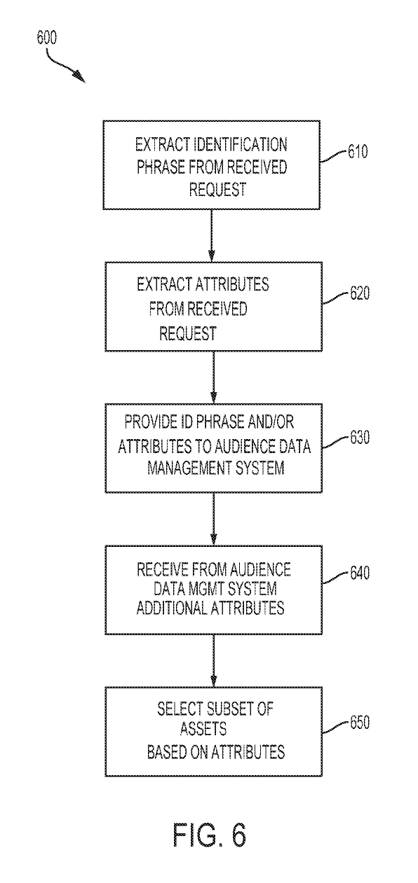

A subset of assets may be selected in any suitable manner. For example, FIG. 6 is a flow chart depicting an example of a process 600 for selecting a subset of assets at block 530 of the process 500. In some embodiments, a content creation system 130 implements operations depicted in FIG. 6 by executing suitable program code. For illustrative purposes, the process 600 is described with reference to the examples depicted in FIGS. 1-5. Other implementations, however, are possible.

At block 610, the process 600 involves extracting, from a received request, an identification phrase. For example, the content creation system 130 executes program code suitable for extracting an identification phrase 123 from request 120.

At block 620, the process 600 involves extracting, from the received request, one or more attributes received with the request. For example, the content creation system 130 executes program code suitable for extracting attributes 125 from request 120. The extracted attributes are specific to a recipient, such as recipient 180. The extracted identification phrase is associated with the recipient.

At block 630, the process 600 involves providing the identification phrase, or the extracted attributes, or both, to a data management system. For example, the content creation system 130 executes program code suitable for providing the extracted identification phrase 123 and the extracted attributed 125 to the data management system 140 via a data network. The data management system 140 determines one or more additional attributes 145 based on the identification phrase 123, the extracted attributes 125, or both. In some embodiments, the extracted attributes 125 include traits specific to the remote computing system 110, such as the IP address. In additional or alternative embodiments, the additional attributes 145 include traits specific to the recipient 180 such as a geographical location, a recent browsing history, a membership in a particular retail loyalty program, an age range, an income range, a probable gender, etc.

At block 640, the process 600 involves receiving, from the data management system, the additional attributes determined by the data management system. For example, the content creation system 130 executes program code suitable for receiving, via a data network, one or more electronic communications from the data management system 140 that includes the additional attributes 145 determined by the data management system 140.

At block 650, the process 600 involves selecting a subset of assets from a collection of assets, the selection being based on one or more of the attributes extracted from the request, or one or more of the additional attributes received from the data management system, or based on both. For example, the content creation system 130 executes program code suitable for communicating, via a data network, with asset repository 150 and selecting a subset of assets 133 from the collection of assets 153.

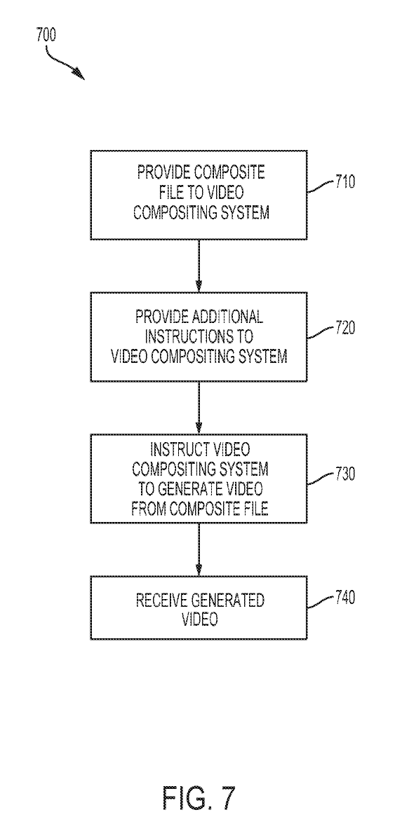

Video content may be generated from the composite content file in any suitable manner. For example, FIG. 7 is a flow chart depicting an example of a process 700 for generating the customized electronic video content item that is provided using the process 500. In some embodiments, a content creation system 130 implements operations depicted in FIG. 7 by executing suitable program code. For illustrative purposes, the process 700 is described with reference to the examples depicted in FIGS. 1-6. Other implementations, however, are possible.

At block 710, the process 700 involves providing a composite content file to a video compositing system. For example, the content creation system 130 executes suitable program code for transmitting or otherwise providing the composite content file 135 to the video compositing system 160. In some embodiments, the video compositing system 160 is a distributed video compositing server system having multiple nodes that perform parallel operations for rendering video content using the compose content file 135.

At block 720, the process 700 involves providing additional instructions to the video compositing system. The additional instructions describe one or more details regarding generation of the electronic video content item. In some embodiments, block 720 may be omitted.

At block 730, the process 700 involves instructing the video compositing system to generate an electronic video content item. For example, the content creation system 130 transmits one or more electronic communications to the video compositing system 160 to render or otherwise generate the electronic video content item based on the composite content file, the additional instructions, or both.

In some embodiments, the composite content file 135 includes reference addresses that are directed to the particular video elements associated with particular template layers. The video compositing system 160 communicates with an asset repository 150 via a network to access the assets using the addresses. In additional or alternative embodiments, the video compositing system communicates with the content creation system 130 and accesses one or more of the associated video elements using the addresses.

In some embodiments, the video compositing system 160 generates the electronic video advertisement 170 by rendering of the composite content file 135. In the rendered version of the composite content file 135, the combination of assets used in creating the composite content file 135 is visible, audible, or otherwise perceptible in the generated electronic video advertisement 170.

At block 740, the process 700 involves receiving the generated electronic video content item from the video compositing system. For example, the content creation system 130 executes suitable program code for receiving the electronic video advertisement 170 or other customized video content from the video compositing system 160.

In some embodiments, the generated electronic content item is received in real-time relative to providing the composite content file to the video compositing system at block 710. For example, a period of time elapses between content creation system 130 providing the composite content file 135 and receiving the generated electronic video advertisement 170 from the video compositing system 160. In some embodiments, this period of time is sufficiently short such that recipient 180 does not notice a delay in the display of the electronic video content item.

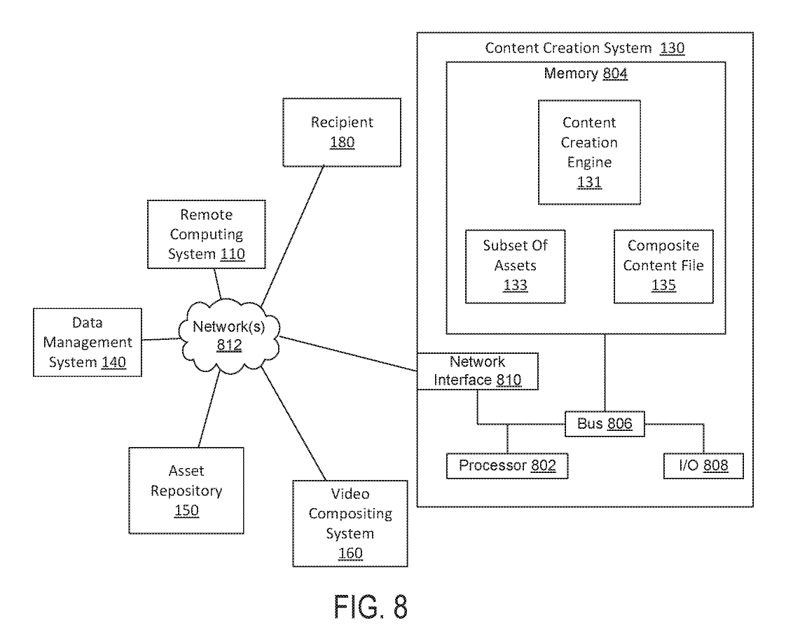

Any suitable computing system or group of computing systems can be used for performing the operations described herein. For example, FIG. 8 is a block diagram depicting an example implementation of a content creation system according to certain embodiments.

The depicted example of the content creation system 130 includes one or more processors 802 communicatively coupled to one or more memory devices 804. The processor 802 executes computer-executable program code and/or accesses information stored in the memory device 804. Examples of processor 802 include a microprocessor, an application-specific integrated circuit (“ASIC”), a field-programmable gate array (“FPGA”), or other suitable processing device. The processor 802 can include any number of processing devices, including one.

The memory device 804 includes any suitable non-transitory computer-readable medium for storing a content creation engine 131, the subset of assets 133, and the composite content file 135. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The content creation system 130 may also include a number of external or internal devices such as input or output devices. For example, the content creation system 130 is shown with an input/output (“I/O”) interface 808 that can receive input from input devices or provide output to output devices. A bus 806 can also be included in the content creation system 130. The bus 806 can communicatively couple one or more components of the content creation system 130.

The content creation system 130 executes program code that configures the processor 802 to perform one or more of the operations described above with respect to FIGS. 1-7. The program code includes, for example, one or more of the content creation engine 131, the composite content file 135, or other suitable applications or memory structures that perform one or more operations described herein. The program code may be resident in the memory device 804 or any suitable computer-readable medium and may be executed by the processor 802 or any other suitable processor. In some embodiments, the program code described above, the content creation engine 131, the subset of assets 133, and the composite content file 135 are stored in the memory device 804, as depicted in FIG. 8. In additional or alternative embodiments, one or more of the content creation engine 131, the subset of assets 133, the composite content file 135, and the program code described above are stored in one or more memory devices accessible via a data network, such as a memory device accessible via a cloud service.

The content creation system 130 depicted in FIG. 8 also includes at least one network interface 810. The network interface 810 includes any device or group of devices suitable for establishing a wired or wireless data connection to one or more data networks 812. Non-limiting examples of the network interface 810 include an Ethernet network adapter, a modem, and/or the like. The content creation system 130 is able to communicate with one or more of the remote computing system 110, the data management system 140, the asset repository 150, the video compositing system 160, and the recipient 180 using the network interface 810.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A computer-implemented method of creating, generating, and delivering personalized electronic video advertisements, the method comprising:
receiving, by a processing device and from a remote computing system, a request to provide an electronic video advertisement, the request representing attributes specific to a recipient;
responsive to receiving the request, accessing a collection of assets comprising individual templates and elements of video content items;
selecting, by the processing device and from the collection of assets, a subset of the assets based on the attributes represented by the request, wherein the subset of assets includes a particular template and particular elements of video content, wherein the particular template is selected based on the represented attributes and comprises an offer layer, wherein the particular elements are selected based on the represented attributes;
generating, by the processing device, a dynamic offer based on a combination of assets included in the subset of assets;
creating, by the processing device and from the selected subset of assets, a composite content file that comprises the particular template, the generated dynamic offer, and a combination of assets from the selected subset of assets, wherein the generated dynamic offer is associated with the offer layer of the particular template; and
providing, in response to the request and for the recipient, the electronic video advertisement that is generated from the composite content file, wherein the combination of assets is perceptible in the generated electronic video advertisement.

2. The method of claim 1, wherein the selected particular elements of video content items includes one or more of a text element, an audio element, a still image element, a video clip element, or an effect element.

3. The method of claim 1, wherein the generated electronic video advertisement is provided in real-time in response to the request.

4. The method of claim 3, wherein providing the generated electronic video advertisement in real-time comprises providing the generated electronic video advertisement in a period of time sufficiently short to prevent a human-perceptible delay between the request and a display of the electronic video advertisement.

5. The method of claim 1, further comprising:
generating the electronic video advertisement, wherein generating the electronic video advertisement comprises:
providing the composite content file to a distributed video compositing server system,
instructing the distributed video compositing server system to generate the electronic video advertisement, and
providing additional instructions to the distributed video compositing server system, the additional instructions describing details regarding the generation of the electronic video advertisement, wherein the additional instructions include one or more of a screen resolution, a video file format, or a delivery application; and
receiving the generated electronic video advertisement from the distributed video compositing server system, wherein the generated advertisement comprises a rendered video file of the composite content file.

6. The method of claim 1, wherein selecting the subset of assets based on the attributes represented by the request comprises:
extracting, from the request, an identification phrase and one or more of attributes received with the request;
providing the identification phrase and the one or more extracted attributes to a data management system;
receiving, from the data management system, one or more additional attributes, the one or more additional attributes based on a browser history associated with the identification phrase and a demographic profile associated with the extracted attributes; and
selecting the subset of assets based on the one or more extracted attributes and the one or more additional attributes.

7. The method of claim 1, wherein creating the composite content file comprises:
selecting, from the selected subset of assets, the template, wherein the template comprises multiple layers;
associating a background element from the selected particular elements of video content items with a first layer of the template that is capable of being associated with background elements;
associating a video clip element from the selected particular elements of video content items with a second layer of the template that is capable of being associated with video clip elements; and
associating an audio element from the selected particular elements of video content items with a third layer of the template that is capable of being associated with audio elements.

8. The method of claim 7, further comprising associating an additional element from the selected particular elements of video content items with an additional layer of the template, wherein the additional element is previously provided by a user.

9. A system for creating, generating, and delivering personalized electronic video advertisements, the system comprising:
a processor; and
a non-transitory computer-readable medium communicatively coupled to the processor,
wherein the processor is configured to execute program code stored to the non-transitory computer-readable medium for performing operations comprising:
receiving, by a processing device and from a remote computing system, a request to provide an electronic video advertisement, the request representing attributes specific to a recipient;
responsive to receiving the request, accessing a collection of assets comprising individual templates and elements of video content items;
selecting, by the processing device and from the collection of assets, a subset of the assets based on the attributes represented by the request, wherein the subset of assets includes a particular template and particular elements of video content, wherein the particular template is selected based on the represented attributes and comprises an offer layer, wherein the particular elements are selected based on the represented attributes;
generating, by the processing device, a dynamic offer based on a combination of assets included in the subset of assets;
creating, by the processing device and from the selected subset of assets, a composite content file that comprises the particular template, the generated dynamic offer, and a combination of assets from the selected subset of assets, wherein the generated dynamic offer is associated with the offer layer of the particular template; and
providing, in response to the request and for the recipient, the electronic video advertisement that is generated from the composite content file, wherein the combination of assets is perceptible in the generated electronic video advertisement.

10. The system of claim 9, further comprising:
generating the electronic video advertisement, wherein generating the electronic video advertisement comprises:
providing the composite content file to a distributed video compositing server system,
instructing the distributed video compositing server system to generate the electronic video advertisement, and
providing additional instructions to the distributed video compositing server system, the additional instructions describing details regarding the generation of the electronic video advertisement, wherein the additional instructions include one or more of a screen resolution, a video file format, or a delivery application; and
receiving the generated electronic video advertisement from the distributed video compositing server system, wherein the generated advertisement comprises a rendered video file of the composite content file.

11. The system of claim 9, wherein selecting the subset of assets based on the attributes represented by the request comprises:
extracting, from the request, an identification phrase and one or more of attributes received with the request;
providing the identification phrase and the one or more extracted attributes to a data management system;
receiving, from the data management system, one or more additional attributes, the one or more additional attributes based on a browser history associated with the identification phrase and a demographic profile associated with the extracted attributes; and
selecting the subset of assets based on the one or more extracted attributes and the one or more additional attributes.

12. The system of claim 9, wherein creating the composite content file comprises:
selecting, from the selected subset of assets, the template, wherein the template comprises multiple layers;
associating a background element from the selected particular elements of video content items with a first layer of the template that is capable of being associated with background elements;
associating a video clip element from the selected particular elements of video content items with a second layer of the template that is capable of being associated with video clip elements; and
associating an audio element from the selected particular elements of video content items with a third layer of the template that is capable of being associated with audio elements.

13. The system of claim 9, further comprising associating an additional element from the selected particular elements of video content items with an additional layer of the template, wherein the additional element is previously provided by a user.

14. A non-transitory computer-readable medium embodying program code executable by a processing device, the non-transitory computer-readable medium comprising:
program code for receiving, by a processing device and from a remote computing system, a request to provide an electronic video advertisement, the request representing attributes specific to a recipient;
program code for, responsive to receiving the request, accessing a collection of assets comprising individual templates and elements of video content items;
program code for selecting, by the processing device and from the collection of assets, a subset of the assets based on the attributes represented by the request, wherein the subset of assets includes a particular template and particular elements of video content, wherein the particular template is selected based on the represented attributes and comprises an offer layer, wherein the particular elements are selected based on the represented attributes;
program code for generating, by the processing device, a dynamic offer based on a combination of assets included in the subset of assets;
program code for creating, by the processing device and from the selected subset of assets, a composite content file that comprises the particular template, the generated dynamic offer, and a combination of assets from the selected subset of assets, wherein the generated dynamic offer is associated with the offer layer of the particular template; and
program code for providing, in response to the request and for the recipient, the electronic video advertisement that is generated from the composite content file, wherein the combination of assets is perceptible in the generated electronic video advertisement.

15. The non-transitory computer-readable medium of claim 14, wherein the generated electronic video advertisement is provided in real-time in response to the request.

16. The non-transitory computer-readable medium of claim 15, wherein the program code for providing the generated electronic video advertisement in real-time comprises program code for providing the generated electronic video advertisement in a period of time sufficiently short to prevent a human-perceptible delay between the request and a display of the electronic video advertisement.

17. The non-transitory computer-readable medium of claim 14, further comprising program code for:
generating the electronic video advertisement, wherein generating the electronic video advertisement comprises:
providing the composite content file to a distributed video compositing server system,
instructing the distributed video compositing server system to generate the electronic video advertisement, and
providing additional instructions to the distributed video compositing server system, the additional instructions describing details regarding the generation of the electronic video advertisement, wherein the additional instructions include one or more of a screen resolution, a video file format, or a delivery application; and
receiving the generated electronic video advertisement from the distributed video compositing server system, wherein the generated advertisement comprises a rendered video file of the composite content file.

18. The non-transitory computer-readable medium of claim 14, wherein the program code for selecting the subset of assets based on the attributes represented by the request comprises program code for:
extracting, from the request, an identification phrase and one or more of attributes received with the request;
providing the identification phrase and the one or more extracted attributes to a data management system;
receiving, from the data management system, one or more additional attributes, the one or more additional attributes based on a browser history associated with the identification phrase and a demographic profile associated with the extracted attributes; and
selecting the subset of assets based on the one or more extracted attributes and the one or more additional attributes.

19. The non-transitory computer-readable medium of claim 14, wherein the program code for creating the composite content file comprises program code for:
selecting, from the selected subset of assets, the template, wherein the template comprises multiple layers;
associating a background element from the selected particular elements of video content items with a first layer of the template that is capable of being associated with background elements;
associating a video clip element from the selected particular elements of video content items with a second layer of the template that is capable of being associated with video clip elements; and
associating an audio element from the selected particular elements of video content items with a third layer of the template that is capable of being associated with audio elements.

20. The non-transitory computer-readable medium of claim 19, further comprising program code for associating an additional element from the selected particular elements of video content items with an additional layer of the template, wherein the additional element is previously provided by a user.
